(19) United States
(12) Patent Application Publication
(10) Pub. No.: US 2021/0248644 A1
(43) Pub. Date: Aug. 12, 2021

(54) METHOD AND APPARATUS FOR REAL-TIME MATCHING OF PROMOTIONAL CONTENT TO CONSUMED CONTENT

(71) Applicant: Rovi Guides, Inc., San Jose, CA (US)

(72) Inventor: Juan Gerardo Menendez, Sunnyvale, CA (US)

(21) Appl. No.: 16/789,239

(22) Filed: Feb. 12, 2020

(51) Int. Cl. G06Q 30/02; G06N 3/08; G06F 16/23

(52) U.S. Cl. CPC G06Q 30/0269; G06Q 30/0255; G06F 16/23; G06N 3/08; G06Q 30/0277

(57) ABSTRACT

Systems and methods for real-time matching of promotional content to content that a user is currently consuming. Content that is currently being consumed is classified into descriptive categories, such as by determining a vector of content features where this vector is in turn used to classify the currently-played content. Promotional content having classifications that match the classifications of the currently-played content is then determined. Matching promotional content may then be played for the user in real time. In this manner, systems and processes of embodiments of the disclosure may identify promotional content matching what the user is currently watching, so as to present users promotional content tailored to subject matter the user is currently interested in.

### BACKGROUND

Current computing systems provide a certain amount of ability to match promotional content to end-users. Such systems attempt to tailor promotional content to the wants and needs of the user, to present him or her with offers for desired products or services. However, such systems are currently subject to limitations. In particular, matching promotional content to users continues to be limited in its ability to reach audiences with high conversion rates. Contemporary systems often simply play promotional content at predetermined intervals, play promotional content selected according to user-defined preferences, or attempt to divine these user preferences indirectly such as via past purchases, user search history, or the like. These and other approaches have demonstrated a limited ability to predict true user preferences at any particular point in time, and have thus shown limited ability to select promotional content that accurately matches a user's preferences or interests at the time this promotional content would be displayed.

Accordingly, to overcome the limited ability of computer based systems to match users with effective promotional content, systems and methods are described herein for a computer-based process that classifies content into specified categories as it is being played, and selects promotional content matching these categories. Thus, for example, matched promotional content may be played for the user in real time while the content still matches the specified categories, or matching promotional content may be played at a transition in which the played content shifts categories. In this manner, systems of embodiments of the disclosure may play promotional content in real time, which matches what the user is currently watching. This increases the likelihood that the promotional content is targeted to something of current interest to the user, thus increasing the effectiveness of such promotional content.

In more detail, systems of embodiments of the disclosure may determine classifications of content as that content is being consumed, such as by classifying each content frame as it is displayed for consumption. When the content maintains a similar set of classifications for a period of time, such as during a particular scene in which the setting and/or subject remains the same, a period of time in which the same or similar products are being shown, or the like, the system may determine that the user is interested in content with those particular classifications. Accordingly, promotional content having one or more of the same or similar classifications, or any one or more classifications that correspond thereto, may then be selected and transmitted for display to the user. This promotional content may be displayed for the user at any time, although in some situations it may be desirable to display the promotional content while, or shortly after, the consumed content contains those particular classifications.

Content may be classified according to one or more machine learning models. For example, the system may employ one or more known machine learning classifiers, such as a recurrent neural network trained to receive content frames as input and to generate various features of those input frames as output. Further machine learning models may be employed for classification based on these features. Any type or types of machine learning models suitable for classification are contemplated. In one embodiment of the disclosure, the classification process may be broken into steps each handled by a different model or models. For instance, relevant machine learning features used for classification may first be determined, and those features may then be used to generate classifications of the content. These features may also be used to update a user profile, so that user profiles maintain stored features of content the user has consumed. These stored features may then be classified to determine the types of content the user has consumed in the past, which may in turn indicate the types of content he or she is interested in, and thus the types of promotional content that may be effective.

Additional machine learning models may be employed to match promotional content to the content currently being consumed by the user. In some embodiments of the disclosure, a set of machine learning models may be trained to generate a yes/no promotional content match output from inputs that include the determined content classifications, that is, to recommend promotional content that matches certain classifications. These models may be trained using labeled sets of classifications that are deemed to match, or not to match, promotional content. In this manner, producers of promotional content may specify certain classifications they deem as effective matches for their promotional content, and the machine learning models may then be trained to determine whether the user is currently consuming content that is a match for their promotional content. If so, this promotional content may be deemed as a good match for the user, and may be played for the user accordingly.

To improve the ability of such models to match user-consumed content to promotional content, user behavior information may be employed as an additional input. More specifically, the promotional content matching models may be configured and trained to take in user behavior information as an input, in additional to content classifications. Behavior information may include any aspect of user behavior, such as applications the user has open, websites the user is currently viewing, and the like. The model may thus be trained on both classifications deemed as effective matches for promotional content, as well as user behaviors that are found to be effective predictors of interest in that promotional content.

As above, promotional content may be displayed for the user at any time deemed appropriate. For example, promotional content may be displayed after a particular content segment bearing particular classifications is completed, e.g., at the transition between one segment or scene matching the promotional content, and the next segment or scene. As another example, promotional content may instead be played immediately upon matching with a particular content segment. That is, once matching promotional content is determined, the content the user is currently viewing or consuming may be interrupted for play of the promotional content.

Embodiments of the disclosure may be applied to match promotional content to current consumption of any type of content. This includes both content such as video and audio comprising time-varying images or other signals, as well as content such as web pages which are largely time-invariant but for which only a portion may be viewed at a time. Promotional content may thus be matched with any currently-displayed portion or segment of any type of content that may be consumed by a user.

### BRIEF DESCRIPTION OF THE FIGURES

The above and other objects and advantages of the disclosure will be apparent upon consideration of the following detailed description, taken in conjunction with the accompanying drawings, in which like reference characters refer to like parts throughout, and in which:

FIGS. 1A and 1B are block diagram representations conceptually illustrating operation of illustrative systems for real-time matching of promotional content to consumed content, in accordance with embodiments of the disclosure;

FIG. 2 is a block diagram of an illustrative system for matching promotional content with consumed content, in accordance with embodiments of the disclosure;

FIG. 3 is an illustrative representation of texture analysis of an image, in accordance with embodiments of the disclosure;

FIG. 4 is an illustrative representation of shape intensity analysis of an image, in accordance with embodiments of the disclosure;

FIG. 5 is a block diagram of an illustrative device for matching promotional content with consumed content, in accordance with embodiments of the disclosure;

FIG. 6 is a block diagram of an illustrative system for matching promotional content with consumed content, in accordance with embodiments of the disclosure;

FIG. 7 is a flowchart of an illustrative process for generation of feature vectors, in accordance with embodiments of the disclosure;

FIG. 8 is a flowchart of an illustrative process for training a machine learning model of FIG. 2;

FIG. 9 is a flowchart of an illustrative process for matching promotional content with consumed content according to generated feature vectors, in accordance with embodiments of the disclosure;

FIG. 10 is a flowchart illustrating further details of an illustrative process for matching promotional content with consumed content according to generated feature vectors, in accordance with embodiments of the disclosure;

FIG. 11 is a flowchart of an illustrative process for matching promotional content with differing portions of a content page, in accordance with embodiments of the disclosure; and

FIG. 12 is a flowchart illustrating further details of aspects of the process of FIG. 11, in accordance with embodiments of the disclosure.

### DETAILED DESCRIPTION

In one embodiment, the disclosure relates to systems and methods for real-time matching of promotional content to content that a user is currently consuming. Content that is currently being consumed is classified into descriptive categories, such as by determining a vector of content features where this vector is in turn used to classify the currently-played content. Promotional content having classifications that match the classifications of the currently-played content is then determined. Matching promotional content may then be played for the user in real time. In this manner, systems and processes of embodiments of the disclosure may identify promotional content matching what the user is currently watching, so as to present users promotional content tailored to subject matter the user is currently interested in.

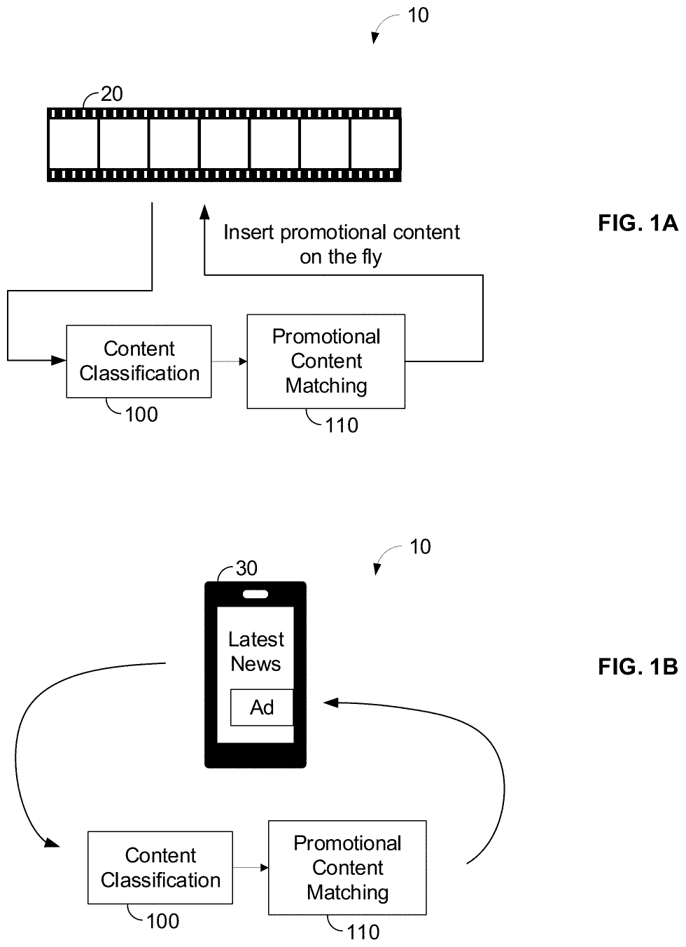

FIGS. 1A and 1B are block diagram representations conceptually illustrating operation of illustrative systems for real-time matching of promotional content to consumed content, in accordance with embodiments of the disclosure. FIG. 1A illustrates a process for content matching in connection with content comprising time varying content such as content made up of a successive series of frames or other information, e.g., video content, audio content, or the like. Here, a content matching system 10 analyzes time varying content 20, which may be a video being consumed by a user. System 10 includes a content classifier 100 and a promotional content matching module 110. The content classifier 100 receives frames (or other portions) of content 20 as they are played for the user. Content classifier 100 classifies each received frame of content 20, thereby assigning one or more categories or classifications to the frame. The promotional content matching module 110 then matches the categories or classifications of this frame to predetermined classifications of various promotional content, to determine whether some promotional content sufficiently matches the categories or classifications of the frame. Matching promotional content may then be inserted into the stream of content 20, so that the user receives promotional content matching the content he or she is currently consuming.

FIG. 1B illustrates content matching in connection with content for which different portions of content are viewed at different times, but in which the content itself does not vary significantly over time. Examples may include mobile web pages, which users scroll through to read and thus view a moving window that displays a portion of the content at a time. In this example, content matching system 10 analyzes the currently-displayed portion of a web page, e.g., a news website whose web page is displayed on a mobile computing device 30, and classifies the currently-displayed page portion as it is displayed on device 30. As above, content classifier 100 assigns one or more categories or classifications to the currently-displayed page portion, whereupon promotional content matching module 110 matches the categories or classifications of this page portion to predetermined classifications of various promotional content. Matching promotional content may then be displayed on the web page, so that the user sees the promotional content while he or she is viewing the page. Notably, the promotional content may be displayed as it is matched with the currently-displayed web page portion, so that the user is presented with promotional content that is related to the content he or she is currently viewing. The promotional content may also be presented on any currently-viewed web page portion, so that the user views the promotional content even if he or she has scrolled elsewhere on the web page.

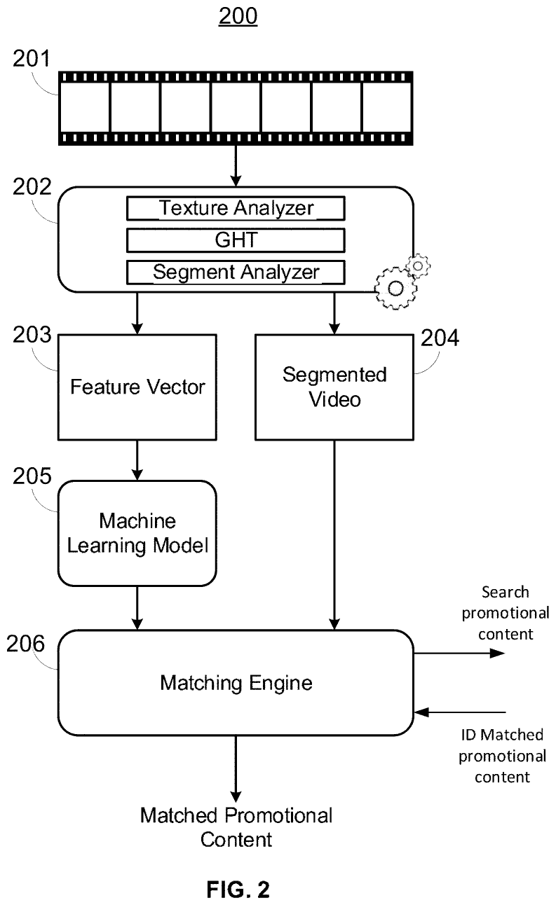

Embodiments of the disclosure contemplate content classification and subsequent promotional content matching in any suitable manner. Many such methods exist. In embodiments of the disclosure, content may be classified by determining relevant textural or visual features, and assembling these features into a vector that may be accompanied by supplemental information such as the sequence position (e.g., timestamp) of the content frame and the duration of the current segment. A machine learning model may then classify these feature vectors, with the resulting classifications matched to classifications of promotional content. Exemplary embodiments of the content classification and matching process are described in U.S. patent application Ser. No. 16/698,618, filed on Nov. 27, 2019, which is hereby incorporated by reference in its entirety. Further embodiments are described in FIGS. 2-4 below.

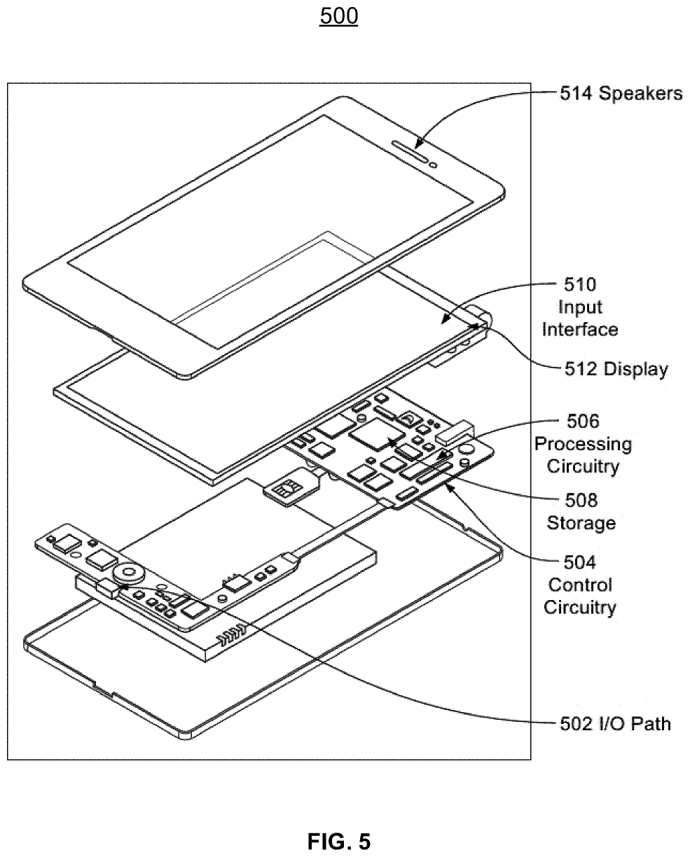

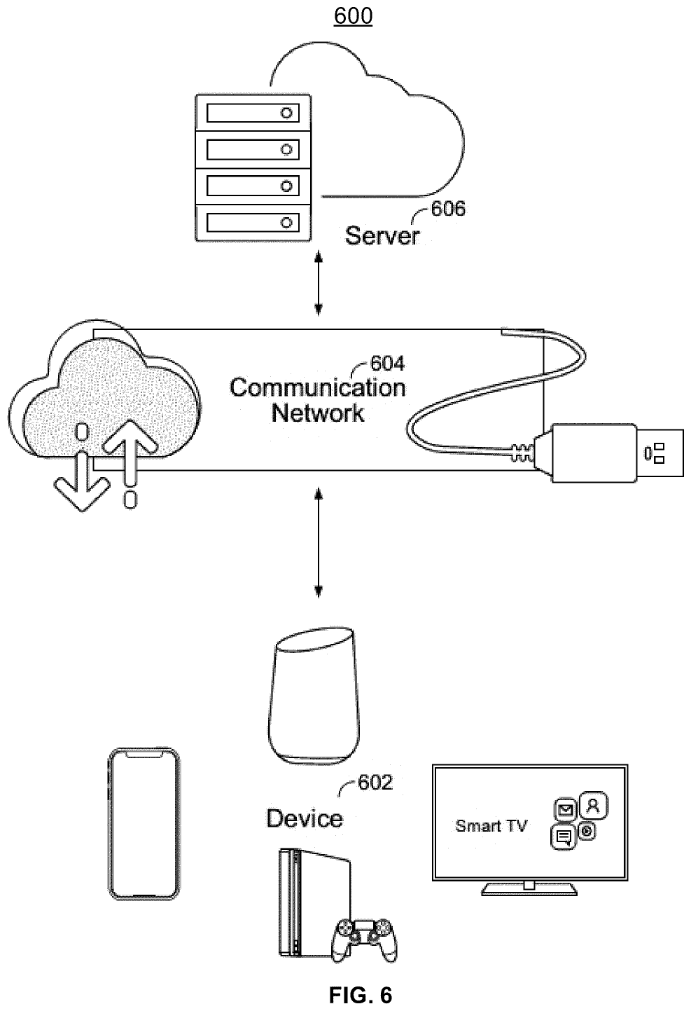

FIG. 2 is a block diagram of an illustrative system 200 for matching promotional content with consumed content, in accordance with embodiments of the disclosure. Video 201 is input to system 200. At least one frame of video 201 is processed using signature analyzer 202, which calculates an electronic signature or set of characteristics of the at least one frame. Such signatures may be any set of descriptive characteristics of the at least one frame that may be used in classification. In embodiments of the disclosure, these characteristics can include image texture information describing the spatial arrangement of visual elements of the input video frame(s). Texture information may be determined in any manner such as according to a dynamic texture model, e.g., a kernel dynamic texture model, a layered dynamic texture model, or a mixed dynamic texture model. Characteristics can also include shape information of image elements, such as that determined according to a Generalized Hough Transform (GHT) or any other method or process. Accordingly, signature analyzer 202 includes a texture analyzer, a GHT, and a segment analyzer. A machine learning model such as a neural network may generate a feature vector from the outputs of the texture analyzer and GHT. The neural network generates feature vectors according to a statistical optimization of the textures in known manner, and may be any neural network suitable for carrying out statistical optimization processes, such as a recurrent neural network (RNN). The output of signature analyzer 202 thus includes feature vector 203 containing the outputs of the texture analyzer and GHT as well as optionally other image feature information as further described below, and segmented video 204. In some embodiments, feature vector 203 includes multiple feature vectors that are respectively mapped to video segments of segmented video 204. Feature vector 203 is analyzed using machine learning model 205 to produce a machine learning model output that is input to recommendation engine 206. Recommendation engine 206 causes a promotional content recommendation to be provided based on the machine learning model output. System 200 may include hardware, such as control circuitry and processing circuitry, as described in the descriptions of FIGS. 5-6, that is configured to perform any of the steps in the process for providing deep recommendations using signature analysis.

As referred to herein, the term “signature analysis” refers to the analysis of a generated feature vector corresponding to at least one frame of a video using a machine learning model. As referred to herein, a signature analysis for video includes signature analysis for one or more static images (e.g., at least one frame of a video). As referred to herein, a video signature includes a feature vector generated based on texture, shape intensity, and temporal data corresponding to at least one frame of a video. As referred to herein, the term “content item” should be understood to mean an electronically consumable user asset, such as television programming, as well as pay-per-view programs, on-demand programs, Internet content (e.g., streaming content, downloadable content, or Webcasts), video, audio, playlists, electronic books, social media, applications, games, any other media, or any combination thereof. Content items may be recorded, played, displayed or accessed by devices. As referred to herein, “content providers” are digital repositories, conduits, or both of content items. Content providers may include cable sources, over-the-top content providers, or other sources of content.

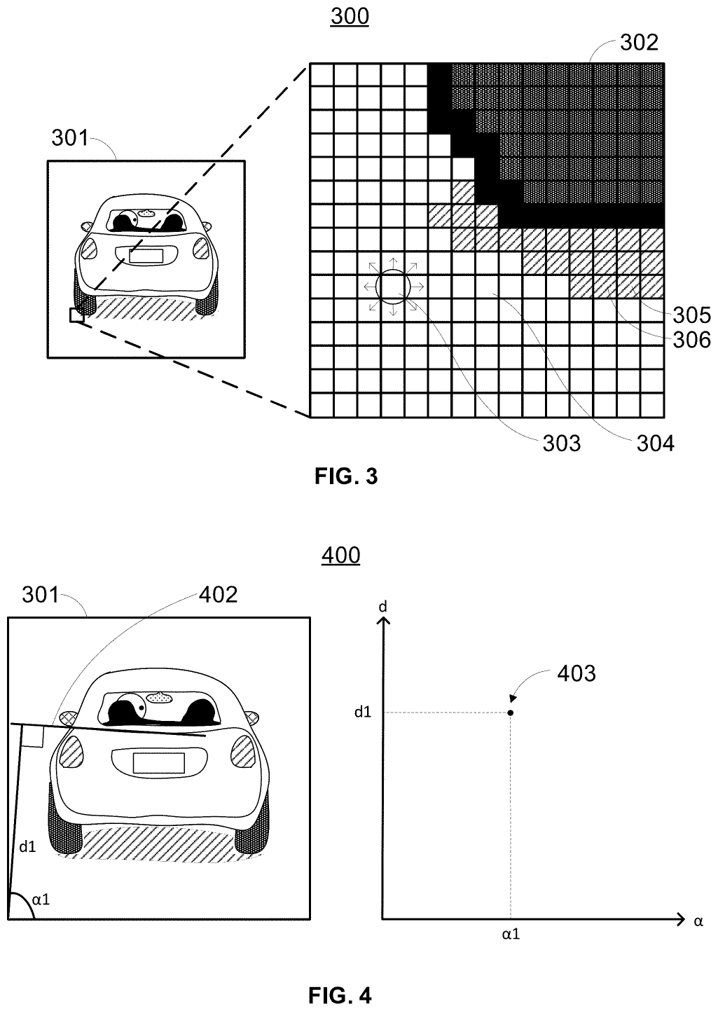

At least one frame of video 201 is used to generate feature vector 203. In some embodiments, the system 200 determines a texture associated with the at least one frame of video 201 using the texture analyzer of signature analyzer 202. The texture analyzer may use a statistical texture measurement method such as edge density and direction, local binary partition, co-occurrences matrices, autocorrelation, Laws texture energy measures, any suitable approach to generating texture features, or any combination thereof. Texture determination is discussed in the description of FIG. 3. In some embodiments, the system 200 transforms the at least one frame of video 201 to generate a shape intensity. A GHT is shown in signature analyzer 202 of FIG. 2 and is further described in FIG. 3, but any suitable method for determining a shape intensity may be used. For example, in some embodiments, a shape intensity determination technique that employs a shape-based snake model (e.g., in combination with a GHT or on its own) may be used. In some embodiments, the recommendation system selects a texture blob and identifies the texture boundary in an image yielding a closed form. Such a closed form may be mapped in an image by inferring the shape based on salient features in the image. For example, the texture analysis is extended to generate a map of the texture, a distance measure for the salient textures is determined (e.g. Mahalanobis distance), and the count of texture pixels at that map location is added. Signature analyzer 202 includes a segment analyzer that, in some embodiments, determines changes in texture and shape intensity across frames of the video (e.g., over time) in order to segment the at least one frame. For example, a sufficiently large change in texture, shape intensity, or a combination thereof between a first frame and a second frame segments them from one another. Changes between frames over time (e.g., changes in texture and shape intensity) may define temporal data used to generate a feature vector corresponding to at least one frame of a video. Segmented video 204 includes segmented frames according to the segment analyzer of signature analyzer 202. In some embodiments, segmented video 204 is mapped to feature vector 203 (e.g., the feature vector is generated using the segmented frames of segmented video 204).

Feature vector 203 is analyzed using machine learning model 205 to produce a machine learning model output. In some embodiments, a machine learning model includes a neural network, a Bayesian network, any suitable computational characterization model, or any combination thereof. In some embodiments, a machine learning model output includes a value, a vector, a range of values, any suitable numeric representation of classifications of a content item, or any suitable combination thereof. For example, the machine learning model output may be one or more classifications and associated confidence values, where the classifications may be any categories into which content may be classified or characterized as. This may include, for instance, genres, products, backgrounds, settings, volumes, actions, any objects, or the like. As is known, machine learning model 205 may be trained in any suitable manner to generate any types or categories of classifications.

In some embodiments, matching engine 206 determines whether a match exists between the output of machine learning model 205 and any promotional content. For instance, classifications output from machine learning model 205 are compared to predetermined classifications of promotional content. Matches between promotional content classifications and classifications of frames of video 201 may be determined in any manner, such as by the number of identical classifications, the degree of similarity of a number of classifications, or in any other manner. Embodiments of the disclosure also contemplate implementation of a machine learning model within matching engine 206, which may determine whether particular promotional content matches the output classifications of machine learning model 205. In embodiments of the disclosure, this machine learning model may be any model capable of determining a match between two sets of classifications. Such a model may, for example, be any machine learning classifier, such as a K-nearest neighbor classifier, a multilayer perceptron, a CNN, or the like. In embodiments of the disclosure, classifiers may be trained on input labeled classification sets, to output a match between the determined classification spaces and the classifications of user content. Classifiers may also be trained in unsupervised manner, such as on predetermined classifications of promotional content.

The machine learning model of matching engine 206 may also be configured to consider user behavior information. That is, various user behavior information may be an input to the model, so that the model is trained to consider user behavior as one or more variables in addition to content classifications. Behavior information may include any aspect of user behavior that may correlate with likelihood of purchasing any product or service, such as applications the user has open, websites the user is currently viewing, purchases made recently or historically, or the like. Labeled user behavior information may thus be used in training the machine learning classifier of engine 206. User behavior information may be stored in any manner, such as in a user profile that may itself be stored in storage 508 or in any other accessible location such as a remote server. Such user profiles may also contain other information used in the content matching processes of embodiments of the disclosure. This other information may, for example, include feature vectors previously generated as above by signature analyzer 202, so that user profiles contain records of the types of content (e.g., classifications) that the user has shown interest in.

Once a match is determined, matching engine 206 may retrieve and transmit the matched promotional content for display to the user, such as by insertion into the content stream of video 201. Matched promotional content may be displayed for the user in any manner, and at any time, including as above immediately upon determining matching promotional content or at the end of the video segment of segmented video 204.

FIGS. 3 and 4 show representations of exemplary mathematical operations performed on image 301 by the texture analyzer and GHT of signature analyzer 202. Although not depicted, the mathematical operations (e.g., texture analysis and Generalized Hough Transform) performed on image 301 may be applied to a series of images (i.e., frames of a video).

FIG. 3 shows illustrative representation 300 of texture analysis of image 301. An enlarged view of image 301 shows pixelwise representation of portion 302 of image 301. Pixel 303 is located in portion 302. The texture of image 301 may be determined by statistical texture measurement methods such as edge density and direction, local binary partition, co-occurrence matrices, autocorrelation, Laws texture energy measures, any suitable approach to generating texture features, or any combination thereof.

In some embodiments, the deep recommendation system uses local binary partition (LBP) to determine a texture associated with at least one frame of a video. For example, each center pixel in image 301 is examined to determine if the intensity of its eight nearest neighbors are each greater than the pixel's intensity. The eight nearest neighbors of pixel 303 have the same intensity. The LBP value of each pixel is an 8-bit array. A value of 1 in the array corresponds to a neighboring pixel with a greater intensity. A value of 0 in the array corresponds to a neighboring pixel with the same or lower intensity. For pixel 303 and pixel 304, the LBP value is an 8-bit array of zeros. For pixel 305 and 306, the LBP value is an 8-bit array of 3 zeroes and 5 ones (e.g., 11100011), corresponding to the 3 pixels of lower intensity and 5 pixels of higher intensity. A histogram of the LBP values for each pixel of the image may be used to determine the texture of the image.

Co-occurrence matrices may be used to determine a texture associated with at least one frame of a video. A histogram indicative of the number of times a first pixel value (e.g., a gray tone or color value) co-occurs with a second pixel value in a certain spatial relationship. For example, a co-occurrence matrix counts the number of times a color value of (0, 0, 0) appears to the left of a color value of (255, 255, 255). The histogram from a co-occurrence matrix may be used to determine the texture of the image. Resulting textures may be output as an element of feature vector 203.

FIG. 4 shows illustrative representation 400 of shape intensity analysis of image 301. In some embodiments, a GHT is used to generate a shape intensity of an image. Although the shape used in representation 400 is a line, any analytically defined shape (e.g., line, circle, or ellipse) or non-analytically defined shape (e.g., an amoeba-like shape) may be used in a GHT. In some embodiments, any suitable shape may be used in a GHT based on, for example, pre-defined shapes or shapes detected in a reference image. For example, silhouettes of objects (e.g., human bodies) or combinations of shapes (e.g., circles, lines, any other suitable shape, or any combination thereof), or any other form may be used as the basis for a GHT in accordance with the present disclosure.

Line 402, depicted as defining the trunk of a car, is extended over the lines of the car for clarity. A perpendicular line at an angle α1 and at distance d1 intersects line 402. A GHT space defined by perpendicular line angles, α, at distances, d, define the axes for the GHT space. The line defining the trunk of the car in image 301 is mapped to point 403 in the GHT space. Line 402 and other determined geometric elements may be output as an element of feature vector 203.

In some embodiments, the methods and systems described in connection with FIGS. 1-4 utilize a device to perform content matching. FIG. 5 is a block diagram of an illustrative device 500, in accordance with some embodiments of the present disclosure. As referred to herein, device 500 should be understood to mean any device that can perform matching of consumed content to promotional content. As depicted, device 500 may be a smartphone or tablet, or may additionally be a personal computer or television equipment. In some embodiments, device 500 may be an augmented reality (AR) or virtual reality (VR) headset, smart speakers, or any other device capable of determining and outputting an indication of matched promotional content.

Device 500 may receive content and data via input/output (hereinafter “I/O”) path 502. I/O path 502 may provide content (e.g., broadcast programming, on-demand programming, Internet content, content available over a local area network (LAN) or wide area network (WAN), and/or other content) and data to control circuitry 504, which includes processing circuitry 506 and storage 508. Control circuitry 504 may be used to send and receive commands, requests, and other suitable data using I/O path 502. I/O path 502 may connect control circuitry 504 (and specifically processing circuitry 506) to one or more communications paths (described below). I/O functions may be provided by one or more of these communications paths, but are shown as a single path in FIG. 5 to avoid overcomplicating the drawing.

Control circuitry 504 may be based on any suitable processing circuitry such as processing circuitry 506. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 504 executes instructions for causing to be provided deep recommendations based on image or signature analysis.

An application on a device may be a stand-alone application implemented on a device or a server. The application may be implemented as software or a set of executable instructions. The instructions for performing any of the embodiments discussed herein of the application may be encoded on non-transitory computer-readable media (e.g., a hard drive, random-access memory on a DRAM integrated circuit, read-only memory on a BLU-RAY disk, etc.) or transitory computer-readable media (e.g., propagating signals carrying data and/or instructions). For example, in FIG. 5 the instructions may be stored in storage 508, and executed by control circuitry 504 of device 500.

In some embodiments, an application may be a client-server application where only the client application resides on device 500 (e.g., device 602), and a server application resides on an external server (e.g., server 606). For example, an application may be implemented partially as a client application on control circuitry 504 of device 500 and partially on server 606 as a server application running on control circuitry. Server 606 may be a part of a local area network with device 602, or may be part of a cloud computing environment accessed via the Internet. In a cloud computing environment, various types of computing services for performing searches on the Internet or informational databases, gathering information for a display (e.g., information for providing deep recommendations for display), or parsing data are provided by a collection of network-accessible computing and storage resources (e.g., server 606), referred to as “the cloud.” Device 500 may be cloud clients that rely on the cloud computing capabilities from server 606 to gather data to populate an application. When executed by control circuitry of server 606, the system may instruct the control circuitry to provide content matching on device 602. The client application may instruct control circuitry of the receiving device 602 to provide matched promotional content. Alternatively, device 602 may perform all computations locally via control circuitry 504 without relying on server 606.

Control circuitry 504 may include communications circuitry suitable for communicating with a content server or other networks or servers. The instructions for carrying out the above-mentioned functionality may be stored and executed on server 606. Communications circuitry may include a cable modem, a wireless modem for communications with other equipment, or any other suitable communications circuitry. Such communications may involve the Internet or any other suitable communication network or paths. In addition, communications circuitry may include circuitry that enables peer-to-peer communication of devices, or communication of devices in locations remote from each other.

Memory may be an electronic storage device provided as storage 508 that is part of control circuitry 504. As referred to herein, the phrase “electronic storage device” or “storage device” should be understood to mean any device for storing electronic data, computer software, or firmware, such as random-access memory, read-only memory, hard drives, optical drives, solid state devices, quantum storage devices, gaming consoles, or any other suitable fixed or removable storage devices, and/or any combination of the same. Nonvolatile memory may also be used (e.g., to launch a boot-up routine and other instructions). Cloud-based storage (e.g., on server 606) may be used to supplement storage 508 or instead of storage 508.

Control circuitry 504 may include display generating circuitry and tuning circuitry, such as one or more analog tuners, one or more MP3 decoders or other digital decoding circuitry, or any other suitable tuning or audio circuits or combinations of such circuits. Encoding circuitry (e.g., for converting over-the-air, analog, or digital signals to audio signals for storage) may also be provided. Control circuitry 504 may also include scaler circuitry for upconverting and downconverting content into the preferred output format of the device 500. Circuitry 504 may also include digital-to-analog converter circuitry and analog-to-digital converter circuitry for converting between digital and analog signals. The tuning and encoding circuitry may be used by the device to receive and to display, to play, or to record content. The tuning and encoding circuitry may also be used to receive guidance data. The circuitry described herein, including for example, the tuning, audio generating, encoding, decoding, encrypting, decrypting, scaler, and analog/digital circuitry, may be implemented using software running on one or more general purpose or specialized processors. Multiple tuners may be provided to handle simultaneous tuning functions. If storage 508 is provided as a separate device from device 500, the tuning and encoding circuitry (including multiple tuners) may be associated with storage 508.

A user may send instructions to control circuitry 504 using user input interface 510 of device 500. User input interface 510 may be any suitable user interface touch-screen, touchpad, stylus and may be responsive to external device add-ons such as a remote control, mouse, trackball, keypad, keyboard, joystick, voice recognition interface, or other user input interfaces. User input interface 510 may be a touchscreen or touch-sensitive display. In such circumstances, user input interface 510 may be integrated with or combined with display 512. Display 512 may be one or more of a monitor, a television, a liquid crystal display (LCD) for a mobile device, amorphous silicon display, low temperature poly silicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 512. Speakers 514 may be provided as integrated with other elements of device 500 or may be stand-alone units. Display 512 may be used to display visual content while audio content may be played through speakers 514. In some embodiments, the audio may be distributed to a receiver (not shown), which processes and outputs the audio via speakers 514.

Control circuitry 504 may allow a user to provide user profile information or may automatically compile user profile information. For example, control circuitry 504 may track user preferences for different video signatures and deep recommendations. In some embodiments, control circuitry 504 monitors user inputs, such as queries, texts, calls, conversation audio, social media posts, etc., to detect user preferences. Control circuitry 504 may store the user preferences in the user profile. Additionally, control circuitry 504 may obtain all or part of other user profiles that are related to a particular user (e.g., via social media networks), and/or obtain information about the user from other sources that control circuitry 504 may access. As a result, a user can be provided with real-time matched promotional content.

Device 500 of FIG. 5 can be implemented in system 600 of FIG. 6 as device 602. Devices from which matched promotional content may be output may function as a standalone device or may be part of a network of devices. Various network configurations of devices may be a smartphone or tablet, or may additionally be a personal computer or television equipment. In some embodiments, device 602 may be an augmented reality (AR) or virtual reality (VR) headset, smart speakers, or any other device capable of outputting matched promotional content to a user.

In system 600, there may be multiple devices but only one of each type is shown in FIG. 6 to avoid overcomplicating the drawing. In addition, each user may utilize more than one type of device and also more than one of each type of device.

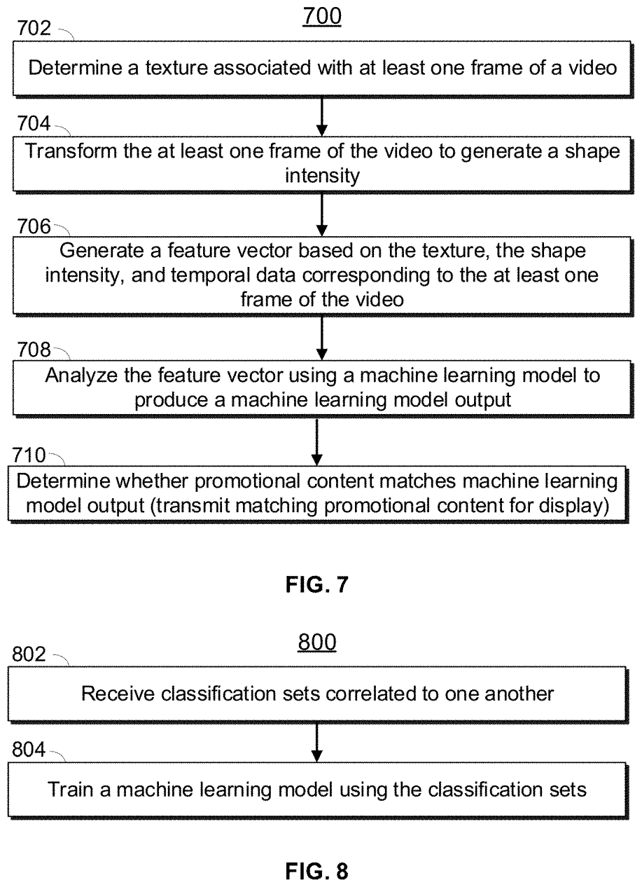

As depicted in FIG. 6, device 602 may be coupled to communication network 604. Communication network 604 may be one or more networks including the Internet, a mobile phone network, mobile voice or data network (e.g., a 4G or LTE network), cable network, public switched telephone network, Bluetooth, or other types of communications network or combinations of communication network. Thus, device 602 may communicate with server 606 over communication network 604 via communications circuitry described above. In should be noted that there may be more than one server 606, but only one is shown in FIG. 6 to avoid overcomplicating the drawing. The arrows connecting the respective device(s) and server(s) represent communication paths, which may include a satellite path, a fiber-optic path, a cable path, a path that supports Internet communications (e.g., IPTV), free-space connections (e.g., for broadcast or other wireless signals), or any other suitable wired or wireless communications path or combination of such paths. Further details of the present disclosure are discussed below in connection with the flowcharts of FIGS. 7-12. It should be noted that the steps of processes of each of FIGS. 7-12, respectively, may be performed by control circuitry 504 of FIG. 5.

FIG. 7 depicts a flowchart of illustrative process 700 for causing matched promotional content to be provided based on a generated feature vector. At Step 702, the content matching system determines a texture associated with at least one frame of a video. A method as described in connection with FIG. 2 may be used to determine texture. For example, the content matching system 200 determines the texture of a video frame of video 201 using co-occurrence matrices.

At Step 704, system 200 transforms the at least one frame of the video to generate a shape intensity. A method as described in the description of FIG. 3 may be used to transform a frame of a video to generate a shape intensity. For example, the deep recommendation system determines the shape intensity of a video frame of video 201 using a GHT to transform the video frame into a representation by angles and distances at which lines of the video frames are located.

At Step 706, the deep recommendation system generates a feature vector based on the texture, the shape intensity, and temporal data corresponding to the at least one frame of the video. The texture determined in step 702 and shape intensity determined in Step 704 may be structured in a feature vector with temporal data indicative of a change in texture and shape intensity over time. Temporal data corresponding to at least one frame of a video includes the time to display the at least one frame (e.g., segment sequence positions, timestamp information, or the like), the number of frames (or, e.g., segment duration or the like), a difference in texture and/or shape intensity over the time or number of frames, any suitable value of change over feature vector values for frames over time, or any combinations thereof.

At Step 708, the deep recommendation system analyzes the feature vector using a machine learning model 205 to produce a machine learning model output. For example, as above, the feature vector is analyzed using a neural network to produce classifications of the video frame.

At Step 710, the system 200 determines whether any promotional content matches the classifications output at Step 708. As above, classifications output at Step 708 may be matched against classifications or classification spaces of promotional content, such as by a trained machine learning model. If a match is found, i.e., the classifications output at Step 708 are sufficiently similar to classifications of particular promotional content, that promotional content may be transmitted for display to the user.

Machine learning model 205 may be trained in any suitable manner. FIG. 8 depicts a flowchart of illustrative process 800 for training a machine learning model 205 using feature vectors. At Step 802, a training system, which may be any computer system capable of executing operations for training a machine learning model, such as device 500, receives labeled feature vectors. For example, a content provider that has generated feature vectors for its content items transmits the generated feature vectors for use in training model 205. The received feature vectors, in some embodiments, are from at least one video, and are labeled as belonging to predetermined classifications.

In some embodiments, the feature vectors received in Step 802 include information indicative of a texture associated with at least one frame of a video, a shape intensity based on a transform of the at least one frame of the video, and temporal data corresponding to the at least one frame of the video. For example, the feature vectors include a value corresponding to the texture of at least one frame (e.g., as determined by methods described in connection with FIGS. 2-3), the shape intensity of the at least one frame (e.g., as determined by methods described in the description of FIGS. 2 and 4), and temporal data determined using changes between respective frames of the at least one frame (e.g., the difference in texture between two frames of the at least one frame).

At Step 804, the training system trains the machine learning model using the labeled feature vectors to produce a trained machine learning model for classifying content feature vectors. In some embodiments, training the machine learning model includes iteratively determining weights for a neural network while minimizing a loss function to optimize the weights, such as by use of a gradient descent method.

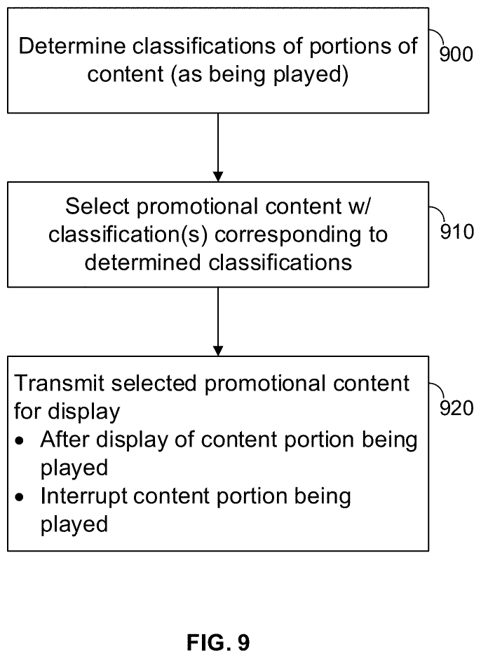

FIG. 9 is a flowchart of an illustrative process for matching promotional content with consumed content according to generated feature vectors, in accordance with embodiments of the disclosure. Initially, system 200 determines classifications of portions of content as those portions of content are consumed at a user device (Step 900). As above, system 200 receives one or more frames of content, such as video 201, determines a corresponding feature vector according to, e.g., output of a texture analyzer and a GHT process, and determines classifications of the feature vector using machine learning model 205, so as to classify the video frame into one or more of a number of discrete classifications.

The system 200 then selects promotional content having one or more classifications corresponding to the classifications output by machine learning model 205 (Step 910). This is accomplished by matching promotional content to the classification output of model 205. As above, matching may be performed in any manner, such as by determination of greater than some predetermined number of identical or similar (within a predetermined difference metric) classifications, or via use of a machine learning model trained to determine whether classified content falls within the classification space of various promotional content.

The system 200 then transmits, or causes to be transmitted, any matched promotional content for display to the user (Step 920). Matched promotional content may be displayed at any time and in any manner, such as after display of a particular content portion being played, e.g., after (including immediately after) the currently-consumed segment 204. Alternatively, or in addition, the content being consumed may be interrupted for immediate display of the matched promotional content. In this manner, system 200 may determine matching promotional content in real time, which matches characteristics of those portions of content that are currently being consumed. This promotional content may then be displayed for the user while the user is still viewing the matching content. In this manner, promotional content may be played to match the user's immediate interests, increasing the likelihood of conversion.

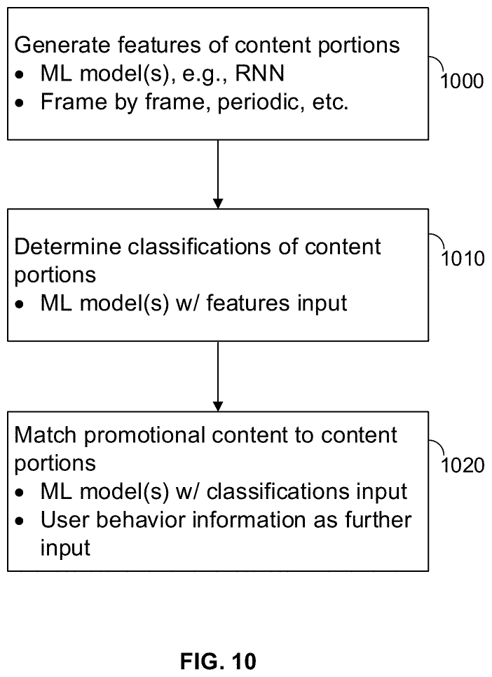

FIG. 10 is a flowchart illustrating further details of an illustrative process for matching promotional content with consumed content according to generated feature vectors, in accordance with embodiments of the disclosure. Process steps of FIG. 10 correspond to Steps 900 and 910 of FIG. 9. In FIG. 10, as in Step 900, system 200 generates features of content portions currently being consumed by a user (Step 1000). In particular, system 200 generates feature vectors of currently consumed content as it is consumed, using, e.g., a texture analyzer, a GHT, and a machine learning model such as an RNN. Feature vectors may be generated for any portion of video such as on a frame by frame basis, i.e. one or more feature vectors for each frame of video, in periodic manner such as according to any regular grouping of frames, or in any other manner.

System 200 then determines classifications of the content portions, such as via one or more machine learning models that take as input the generated features of the content portions and generate the classifications as output (Step 1010). As above, machine learning model 205 may be trained to classify input feature vectors, yielding classifications for each video frame or group of frames.

Once classifications of the currently consumed video portion are determined, system 200 matches promotional content to these video portions (Step 1020). As above, in some embodiments this may be accomplished through use of a machine learning model such as a K-nearest neighbor or other classifier trained to determine whether content classifications fall into the classification space of various promotional content. In these embodiments, the machine learning model would receive as input the classifications of the currently consumed video portion, and would determine as output the identity of any matching promotional content. In certain embodiments, the machine learning model would also receive as input user behavior information describing current user behavior relevant to the likelihood of purchasing any product or service. In these embodiments, the classifier would match the classifications of the currently consumed video portion and the user's current behavior to classifications and corresponding behavior positively correlated with specified promotional content. User behavior may be, for example, determined from current user behavior, retrieved from a stored user profile, or otherwise determined in any manner.

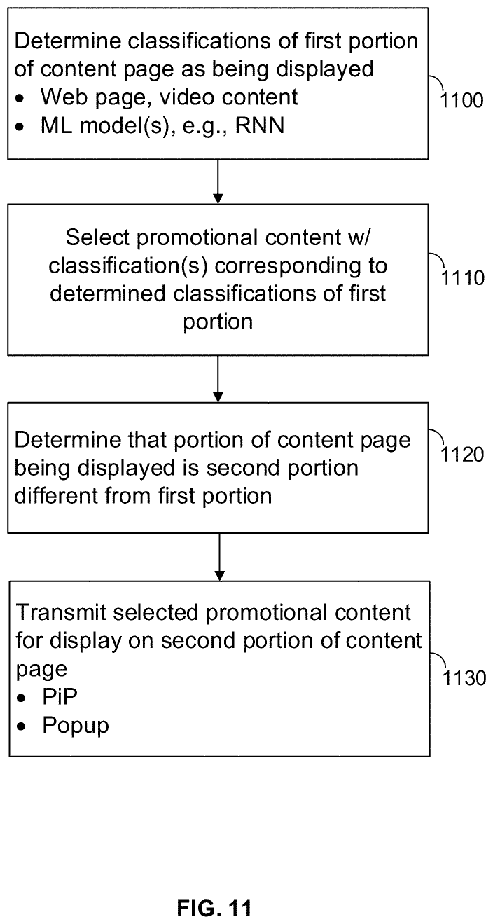

As above, embodiments of the disclosure may be applied to match promotional content to current consumption of time-varying content such as video, audio, or the like. It is noted, though, that embodiments of the disclosure may also be applied to match promotional content to any other type of user-consumed content. This may include content such as web pages and the like, which users may scroll through and thus view only a portion of such content at any given time, even though the content itself is largely time-invariant. FIG. 11 is a flowchart of an illustrative process for matching promotional content with differing portions of a content page, in accordance with embodiments of the disclosure. In the process of FIG. 11, the input to system 200 may be a captured, currently-viewed portion of a web page or other content page, rather than a video 201. Thus, system 200 may determine classifications of a portion of a content page as it is currently being displayed for a user (Step 1100). A captured currently-viewed content page portion may be input to signature analyzer 202, which may calculate a corresponding feature vector 203 and determine classifications of the content page portion in the same manner as described above. Matching engine 206 may then select promotional content with classifications corresponding to the content page classifications determined in Step 1100 (Step 1110). As above, matching may be determined in any manner, such as by a machine learning model trained to determine whether input content page classifications, and optionally other variables such as user behaviors, fall within the classification space of various promotional content.

System 200 may also determine whether the content page portion currently being displayed is different from the content page portion submitted as input to the system 200 (Step 1120). That is, system 200 may determine whether the user has scrolled to a different portion of the content page since the classification of Step 1100 was performed. This determination may be made by a comparison of the image input at Step 1100 to a subsequent image received from the user device.

If the user has scrolled to a different portion of the content page, system 200 may transmit the matched promotional content for display on that portion of the content page to which the user has scrolled, i.e., the portion of the page which the user is currently consuming (Step 1130). This increases the likelihood that the user will actually view the matched promotional content. Embodiments of the disclosure contemplate display of matched promotional content in any manner, so long as such display occurs on the portion of the page which the user is currently consuming. For example, matched promotional content may be displayed in an overlying popup window, such as when the content page is a web page. As another example, matched promotional content may be displayed in a picture-in-picture (PiP) window. Any manner of display is contemplated.

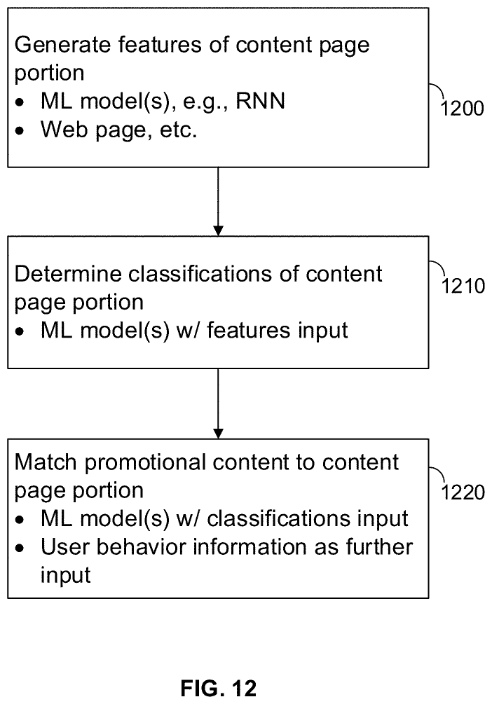

FIG. 12 is a flowchart illustrating further details of aspects of the process of FIG. 11, in accordance with embodiments of the disclosure. Process steps of FIG. 12 correspond to Steps 1100 and 1110 of FIG. 10. In FIG. 12, as in Step 1100, system 200 generates features of content page portions currently being displayed for or consumed by a user (Step 1200). In particular, system 200 generates feature vectors of currently displayed portions of content using, e.g., a texture analyzer, a GHT, and a machine learning model such as an RNN.

System 200 then determines classifications of the currently displayed content portions, such as via one or more machine learning models that take as input the generated features of the content portions and generate the classifications as output (Step 1210). As above, machine learning model 205 may be trained to classify input feature vectors, yielding classifications for each content page portion.

Once classifications of the currently displayed content page portion are determined, system 200 matches promotional content to these content page portions (Step 1220). As above, in some embodiments this may be accomplished through use of a machine learning model such as a K-nearest neighbor or other classifier trained to determine whether content classifications fall into the classification space of various promotional content. In these embodiments, the machine learning model would receive as input the classifications of the currently displayed content page portion, and would determine as output the identity of any matching promotional content. In certain embodiments, the machine learning model would also receive as input user behavior information describing current user behavior relevant to the likelihood of purchasing any product or service. In these embodiments, the classifier would match the classifications of the currently displayed content page portion and the user's current behavior to classifications and corresponding behavior positively correlated with specified promotional content.

The foregoing description, for purposes of explanation, used specific nomenclature to provide a thorough understanding of the disclosure. However, it will be apparent to one skilled in the art that the specific details are not required to practice the methods and systems of the disclosure. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, any content may be classified, whether time-varying content such as audio and/or video, or generally time-invariant content such as web pages and the like. Matching promotional content can be determined in real time and displayed for the user in any time and manner, whether by insertion into a content stream, via a popup or PiP window, immediately upon matching, at the conclusion of a determined segment, or the like. The embodiments were chosen and described in order to best explain the principles of the invention and its practical applications, to thereby enable others skilled in the art to best utilize the methods and systems of the disclosure and various embodiments with various modifications as are suited to the particular use contemplated. Additionally, different features of the various embodiments, disclosed or otherwise, can be mixed and matched or otherwise combined so as to create further embodiments contemplated by the disclosure.

1. A method for facilitating viewing of promotional content, the method comprising:
using control circuitry, determining classifications of a first portion of a content page as the first portion is being displayed, the first portion being that portion of the content page which is being displayed, wherein the determining classifications of the first portion of the content page comprises:
determining textures associated with the first portion of the content page;
transforming the first portion of the content page to generate shape intensities;
generating feature vectors based on the textures and the shape intensities; and
analyzing the feature vectors using one or more machine learning models to determine the classifications of the first portion of the content page;
selecting promotional content having one or more classifications corresponding to the determined classifications of the first displayed portion of the content page;
after the determining classifications, determining that the portion of the content page which is being displayed is a second portion different from the first portion; and
transmitting the selected promotional content for display on the second portion of the content page.

2. (canceled)

3. The method of claim 1, wherein the one or more machine learning models comprise a recurrent neural network.

4. (canceled)

5. The method of claim 1, further comprising using the generated feature vectors to update a user profile.

6. The method of claim 1, wherein the selecting further comprises matching the promotional content to the first portion of the content page using one or more machine learning models having as input the determined classifications of the first portion of the content page.

7. The method of claim 6, wherein the one or more machine learning models further have as input user behavior information.

8. The method of claim 1, wherein the content page is a web page.

9. The method of claim 1, wherein the transmitting further comprises transmitting the selected promotional content for picture in picture (PiP) display.

10. The method of claim 1, wherein the first portion of the content page comprises video content.

11. A system for facilitating viewing of promotional content, the system comprising:
a storage device; and
control circuitry configured to:
determine classifications of a first portion of a content page as the first portion is being displayed, the first portion being that portion of the content page which is being displayed, wherein the control circuitry is configured to determine classifications of the first portion of the content page by:
determining textures associated with the first portion of the content page;
transforming the first portion of the content page to generate shape intensities;
generating feature vectors based on the textures and the shape intensities; and
analyzing the feature vectors using one or more machine learning models to determine the classifications of the first portion of the content page;
select promotional content having one or more classifications corresponding to the determined classifications of the first displayed portion of the content page;
after the determining classifications, determine that the portion of the content page which is being displayed is a second portion different from the first portion; and
transmit the selected promotional content for display on the second portion of the content page.

12. (canceled)

13. The system of claim 11, wherein the one or more machine learning models comprise a recurrent neural network.

14. (canceled)

15. The system of claim 11, wherein the control circuitry is further configured to use the generated feature vectors to update a user profile.

16. The system of claim 11, wherein the selecting further comprises matching the promotional content to the first portion of the content page using one or more machine learning models having as input the determined classifications of the first portion of the content page.

17. The system of claim 16, wherein the one or more machine learning models further have as input user behavior information.

18. The system of claim 11, wherein the content page is a web page.

19. The system of claim 11, wherein the transmitting further comprises transmitting the selected promotional content for picture in picture (PiP) display.

20. The system of claim 11, wherein the first portion of the content page comprises video content.

21-30. (canceled)
